(19) United States
(12) Patent Application Publication
(10) Pub. No.: US 2026/0310735 A1
(43) Pub. Date: Oct. 8, 2026

(54) RECOMMENDING DATA SOURCES BASED ON NEW ACTIVITIES OF A DISTRIBUTED SYSTEM

(71) Applicant: Dell Products L.P., Round Rock, TX (US)

(72) Inventors: ZIJIA WANG, London (GB); XIAOCHEN CHEN, Shanghai (CN); ASHUTOSH P. NANEKAR, Cary, NC (US); NING LI, Shanghai (CN)

(21) Appl. No.: 19/098,860

(22) Filed: Apr. 2, 2025

(51) Int. Cl. G06F 16/953

(52) U.S. Cl. CPC G06F 16/953

(57) ABSTRACT

Methods and systems for desired computer implemented services using data stored in data sources of a distributed system are disclosed. The desired computer implemented services may be provided by recommending data sources based on new activities of a user and/or the data sources. The recommended data sources may be provided by measuring first levels of relevancy and second levels of uncertainty between the new activities and/or the data sources. The recommended data sources may be used with a request template to generate an information request that is processable by information extraction frameworks. From processing the information request, information may be obtained that is used to facilitate a provisioning of the desired computer implemented services.

### FIELD

Embodiments disclosed herein relate generally to provide desired computer implemented services using data stored in data sources of a distributed system. More particularly, embodiments disclosed herein relate to recommending data sources based on new activities of the distributed system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2D show data flow diagrams illustrating operation of a system in accordance with an embodiment.

FIGS. 3A-3C show flow diagrams illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to providing desired computer implemented services using data stored in data sources of a distributed system. The desired computer implemented services may be provided by recommending data sources based on new activities of the distributed system. The new activities may include (a) at least one new interaction of a user with respect to the data sources, (b) a data change in characteristic of at least a portion of the data stored in the data sources, etc.

The recommended data sources may be provided by obtaining a portion of ranked data sources. The data sources may be ranked based on discounted levels of relevancy. The discounted levels of the relevancy may be based on undiscounted levels of relevancy and/or levels of uncertainty. The undiscounted levels of relevancy may correspond to at least relationships between the new activities and/or the data sources. The levels of uncertainty may correspond to variations in the relationships between the new activities and/or the data sources.

The recommended data sources may be used to identify data source identifiers of the data sources of the distributed system. Upon the identification, placeholders of a request template may be replaced with the data source identifiers to generate an information request for the data. The information request may be processable by information extraction frameworks.

Upon processing, by the information extraction frameworks, of the information request, the information may be obtained. The information may be used to facilitate a provisioning of the desired computer implemented services by the distributed system.

In an embodiment, a method for desired computer implemented services using data stored in data sources of a distributed system is disclosed. The method may include: (i) obtaining a data request from a user, the data request being serviceable using a portion of the data stored in data sources, (ii) computing, based on the data request and/or for each of the data sources, a level of uncertainty of relevancy of the data sources with respect to the data request, (iii) computing, for each of the data sources, an undiscounted level of the relevancy of the data sources with respect to the data request, (iv) computing, for each of the data sources, a discounted level of the relevancy of the data sources with respect to the data request using the undiscounted level and the level of uncertainty for each of the data sources, (v) obtaining, using the discounted level of the relevancy for each of the data sources, recommended data sources to service the data request, (vi) obtaining, using the recommended data sources, at least one information request, (vii) obtaining, using the at least one information request, the portion of the data, and/or (viii) using the portion of the data to facilitate provisioning of at least the portion of the desired computer implemented services.

Obtaining the portion of the data may include initiating servicing, by information extraction frameworks that manage access to the data stored in the data sources, the information request to obtain the portion of the data from the data sources.

The data request may be incompatible with the information extraction frameworks for obtaining of the portion of the data.

The information request may include a query usable to obtain the portion of the data, the information extraction frameworks including query execution engines compatible with the query.

The level of uncertainty may be computed using, at least in part, a graph data structure based on the data sources, the graph data structure including (i) nodes corresponding to each of the data sources and/or (ii) edges between the nodes corresponding to relationships between the data sources.

For one of the data sources, the level of uncertainty may be based on embeddings for the one of the data sources.

Computing the undiscounted level of the relevancy of the data sources may include updating the embeddings associated with the nodes by propagating information between a first node of the nodes and/or a second node of the nodes based on an importance level between the first node and/or the second node.

The level of the uncertainty of the relevancy for the one of the data sources may be based on historical changes to the embeddings, an embedding of the embeddings being based at least on an activity with respect to the one of the data sources, and/or the embedding being updated based on changes in the activity.

The method may further include, before computing the level of the uncertainty of the relevancy: (i) identifying the activity with respect to the data sources that is not taken into account by the embeddings, and/or (ii) performing an update to at least one embedding of the embeddings based on the activity to obtain updated embeddings.

The activity may include at least one selected from a group consisting of: (i) a new interaction of a user with respect to the data sources and/or (ii) a data change in characteristic of at least the portion of the data stored in the data sources.

For the one of the data sources, computing the level of the uncertainty of the relevancy of the data sources may include: (i) generating, using a probability distribution and/or the updated embeddings, a probabilistic vector, the probability distribution including a type of variability expected of the at least one embedding of the embeddings and/or the probabilistic vector including at least one fitted parameter of the probability distribution that is fitted to the at least one embedding, (ii) computing, using the probabilistic vector, an entropy of the probability distribution; and/or (iii) obtaining, using the entropy of the probability distribution, the level of the uncertainty of the relevancy of the one of the data sources.

Computing the discounted level of the relevancy of the data sources may include performing at least a mathematical operation using at least the undiscounted level of the relevancy and/or the level of the uncertainty of the relevancy to generate the discounted level of the relevancy, the mathematical operation at least in part discounting the undiscounted level of the relevancy based on the level of the uncertainty of the relevancy.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

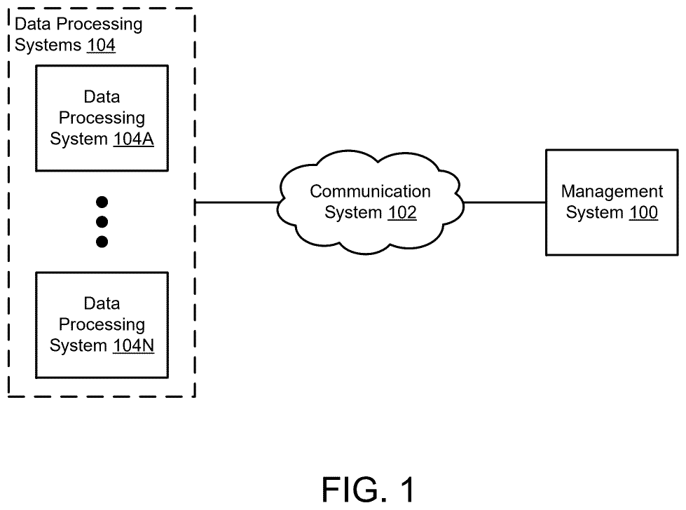

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a data request may be received from an entity of the distributed system. The entity may include (i) a user, (ii) an administrator, and/or (iii) any other stakeholder of the distributed system. Information of the data request may include (i) performance data of the distributed system, (ii) traffic data of the distributed system, (iii) inventory data of items tracked by software of the distributed system, (iv) sales statistics in a database of the distributed system, etc. The data request may be performed by (i) transmitting the data request to the distributed system, (ii) retrieving, based on any parameter of the data request and/or by the distributed system, the information from (a) software, (b) databases, (c) repositories, etc. of the distributed system, and/or (iii) transmitting, by the distributed system, the information to the entity.

However, the information, which has been retrieved by the distributed system, may not include (i) data, (ii) metadata, (iii) statistics, (iv) annotations, etc. that is relevant to at least one requirement and/or activity of the entity on the distributed system. As a result, provisioning, using the information and/or by the entity, of desired computer implemented services may be impacted.

In general, embodiments disclosed here relate to systems and methods for providing desired computer implemented services using data stored in data sources of a distributed system. The desired computer implemented services may be provided by (i) obtaining a data request from a user, the data request being serviceable using a portion of the data stored in data sources, (ii) computing, based on the data request and/or for each of the data sources, a level of uncertainty of relevancy of the data sources with respect to the data request, (iii) computing, for each of the data sources, an undiscounted level of the relevancy of the data sources with respect to the data request, (iv) computing, for each of the data sources, a discounted level of the relevancy of the data sources with respect to the data request using the undiscounted level and/or the level of uncertainty for each of the data sources, (v) obtaining, using the discounted level of the relevancy for each of the data sources, recommended data sources to service the data request, (vi) obtaining, using the recommended data sources, at least one information request, (vii) obtaining, using the at least one information request, the portion of the data, and/or (viii) using the portion of the data to facilitate provisioning of at least the portion of the desired computer implemented services.

The data request may be obtained by receiving, by the distributed system and/or from the entity, the data request for information from an entity. The entity may include (i) a user, (ii) an administrator, and/or (iii) any other stakeholder of the distributed system. The information may include (i) performance data of the distributed system, (ii) traffic data of the distributed system, (iii) inventory data of items tracked by software of the distributed system, (iv) sales statistics in a database of the distributed system, etc.

The level of the uncertainty of the relevancy may be computed by (i) generating a probabilistic vector, (ii) computing an entropy based on the probabilistic vector, and/or (iii) obtaining, from the entropy, the level of uncertainty of the relevancy of the data sources.

The probabilistic vector may be based on a probability distribution that closely includes a behavior of a graph embedding (e.g., an embedding based on a node of a graph data structure) based on the data sources. The probability distribution may include (i) a normal distribution, (ii) a Poisson distribution, (iii) a binomial distribution, (iv) a uniform distribution, etc. Values of the probabilistic distribution may be fitted to generate the probabilistic vector. The probabilistic vector may include a numerical representation (e.g., an n-dimensional vector and/or any other numerical representation) of a graph embedding of a node included in a graph data structure that corresponds to a data source of the data sources.

The entropy may be computed using a first mathematical expression (e.g., (i) Shannon's entropy, (ii) differential entropy for a Gaussian distribution, and/or (iii) any other first mathematical expression). The level of uncertainty of the relevancy of the data sources may be obtained from the entropy using a second mathematical expression in which a first value of the uncertainty is proportional to a second value of the entropy.

The undiscounted level of the relevancy of the data sources may be computed by updating the graph embedding of the node. The node may be included in the graph data structure. The graph data structure may include nodes and/or edges, the nodes corresponding to the data sources, and/or the edges corresponding to relationships between data sources.

The graph embedding may be updated by passing values of updated graph embeddings between the node and/or at least one neighboring node. The values of the updated graph embeddings may correspond to new user interactions of the entity and/or new data of the data sources. Based on the passing of the values of the updated graph embeddings, any component of the graph embedding may be modified to generate updated nodes and/or updated edges.

Using the updated graph embedding of the updated nodes, the undiscounted level of the relevancy of the data sources may be computed. The undiscounted level of the relevancy may be computed with a trained graph neural network (e.g., (a) a trained graph convolution network, (b) a trained graph attention network, (c) a trained dynamic graph neural network, and/or (d) any other trained graph neural network). The trained machine learning model may input (a) levels of importance between the updated graph embeddings of the updated nodes, (b) a scalar matrix that has been generated by the trained machine learning model, etc. into an activation function to generate the undiscounted level of the relevancy for the updated graph embedding.

The discounted level of the relevancy of the data sources may be computed by performing, using at least the undiscounted level of the relevancy and/or at least the level of the uncertainty of the relevancy, at least one mathematical operation. The at least one mathematical operation may be performed using (i) at least one analytical expression, (ii) at least one numerically-determined expression, and/or (iii) any other type of mathematical operation.

The recommended data sources may be obtained by (i) performing a rank-ordering of the data sources based on discounted levels of the relevancy of the data sources to obtain rank-ordered data sources and/or (ii) filtering the rank-ordered data sources based on (a) a threshold discounted level of the relevancy, (b) a highest n number of data sources (e.g., in which n equals (1) three, (2) five, (3) ten, (4) twenty, and/or (5) any other predetermined number), and/or (c) any other measure for filtering the rank-ordered data sources to obtain the recommended data sources.

The at least one information request may be obtained (i) identifying data source identifiers of the recommended data sources and/or (ii) generating, using a request template and/or the data source identifiers, the information request. The information request may be generating by replacing placeholders of the request template with the data source identifiers. The information request may include a query usable to obtain the portion of the data.

The request template may include a structured query template that is not processable by information extraction frameworks. Examples of the information extraction frameworks may include (i) Structured Query Language (SQL), (ii) NoSQL, (iii) ORM (Object Related Mapping) Frameworks, (iv) Apache Hive, (v) ELK (Elasticsearch, Logstash, Kibana) Search, etc. The request template may not be processable because the request template includes the placeholders for inclusion of the data source identifiers. The data source identifiers may include (i) a column name, (ii) a field name, (iii) a data type, and/or (iv) any other data source identifier of the recommended data sources. The information request may be generated by replacing the placeholders of the request template with the data source identifiers.

The portion of the data may be obtained, using the information request, by transmitting the information request to the information extraction frameworks to (i) filter, (ii) prioritize, and/or (iii) retrieve the portion of the data. The portion of the data may include relevant data for use in facilitating the provisioning of the desired computer implemented services.

The portion of the data may be used to facilitate the provisioning at least the portion of the desired computer implemented services by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

To provide the above noted functionality, the system may include management system 100, and data processing systems 104. Each of these components is discussed below.

Data processing systems 104 may include any number of data processing systems (e.g., 104A-104N). The any number of data processing systems may host an entity. The entity may include (i) a user, (ii) an administrator, and/or (iii) any other stakeholder of the distributed system. The entity may generate a data request for information. The data request may be received by the any number of data processing systems (e.g., 104A-104N).

The any number of data processing systems (e.g., 104A-104N) and/or management system 100 may store request templates, graph data structures of data sources, and/or at least one graph neural network in any number of databases, repositories, and/or any other storage systems. The at least one trained graph neural network may include (i) a trained graph convolution network, (ii) a trained graph attention network, (iii) a trained dynamic graph neural network, and/or (iv) any other trained graph neural network.

The any number of data processing systems (e.g., 104A-104N) and/or management system 100 may also utilize information extraction frameworks to utilize the request templates and/or recommended data sources to generate an information request. Examples of the information extraction frameworks may include (i) Structured Query Language (SQL), (ii) NoSQL, (iii) ORM (Object Related Mapping) Frameworks, (iv) Apache Hive, (v) ELK (Elasticsearch, Logstash, Kibana) Search, etc.

The information request may be processed by the any number of data processing systems (e.g., 104A-104N) using the information extraction frameworks to obtain a portion of data. Using the portion of the data, the any number of data processing systems (e.g., 104A-104N) may facilitate the provisioning of desired computer implemented services.

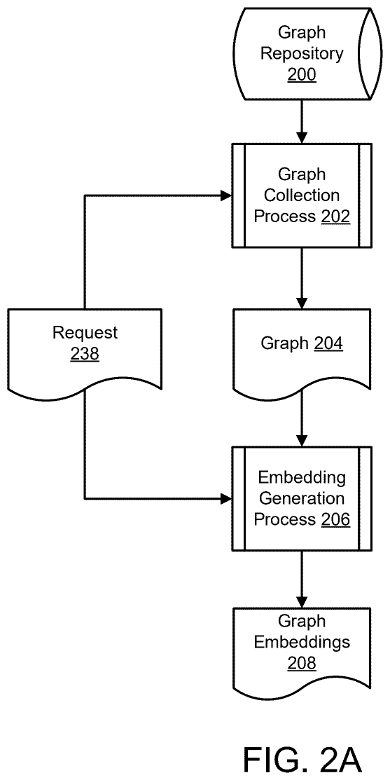

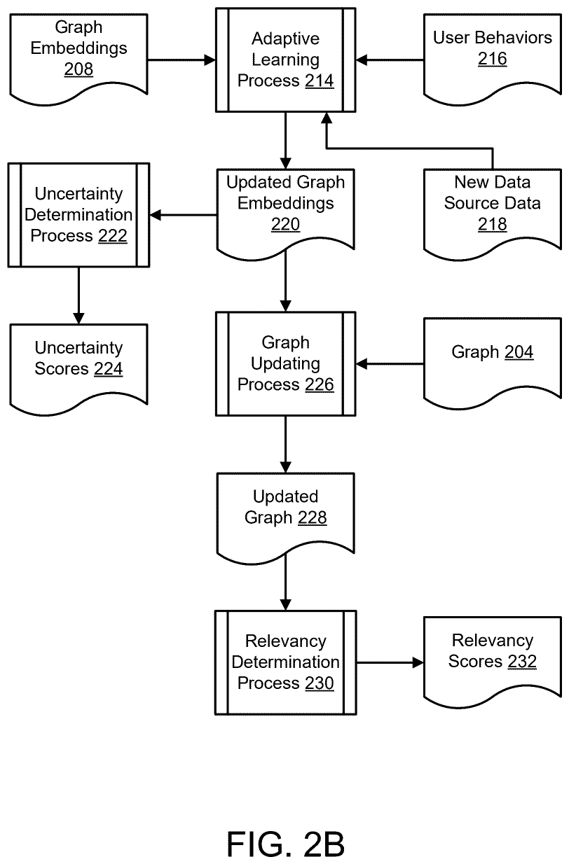

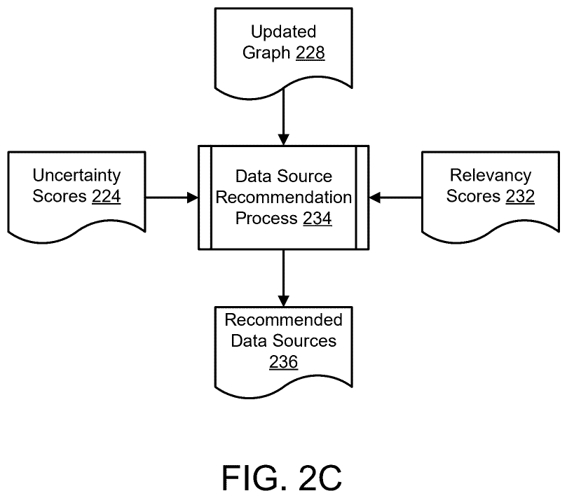

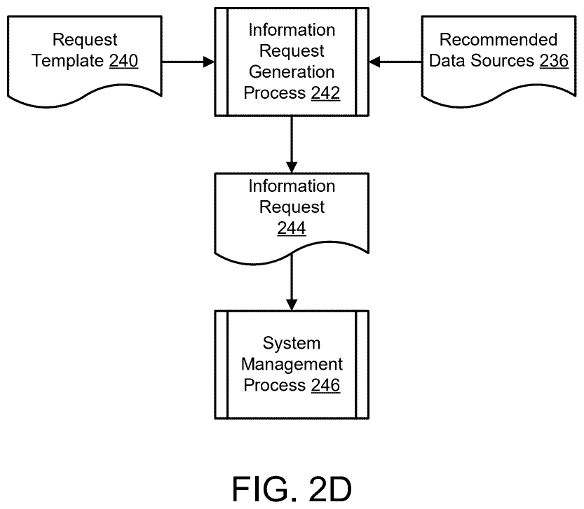

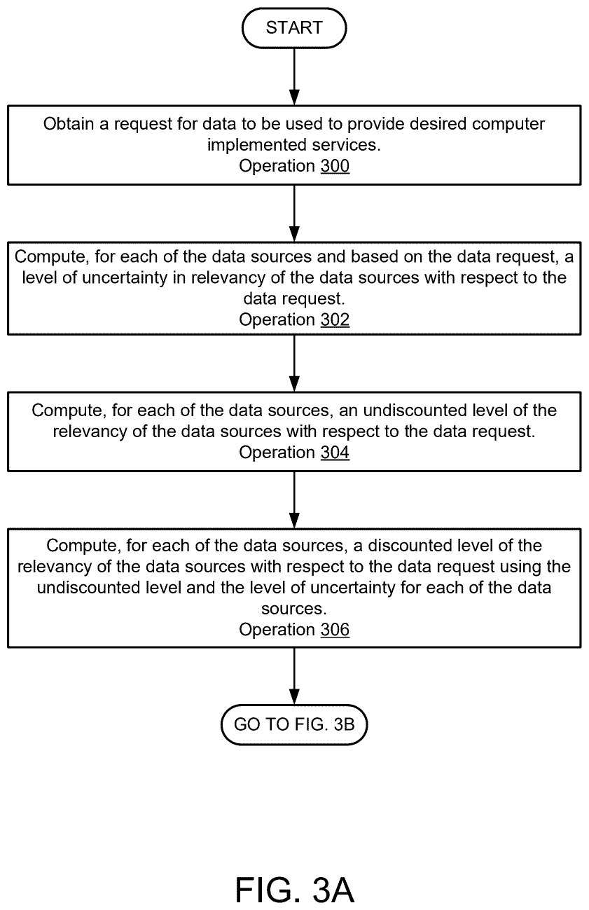

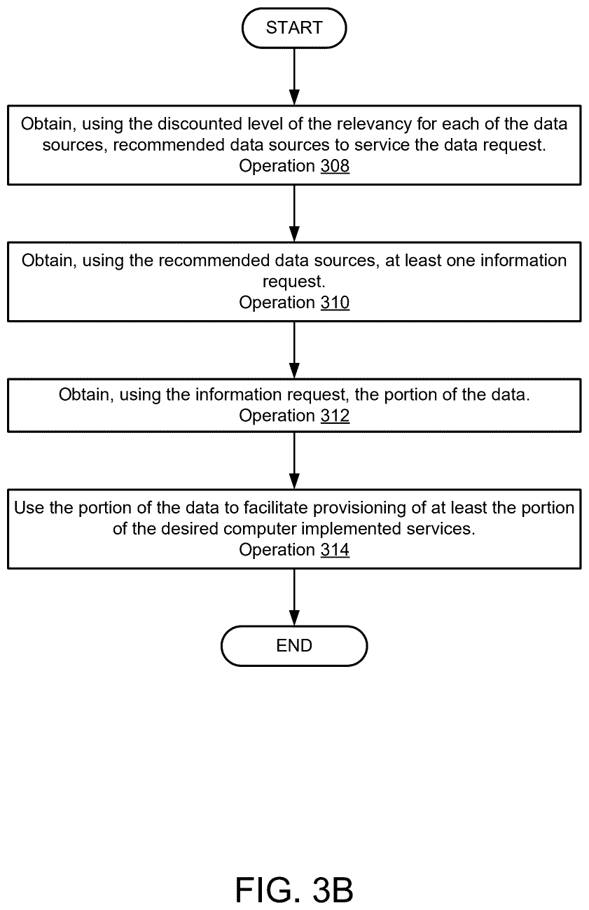

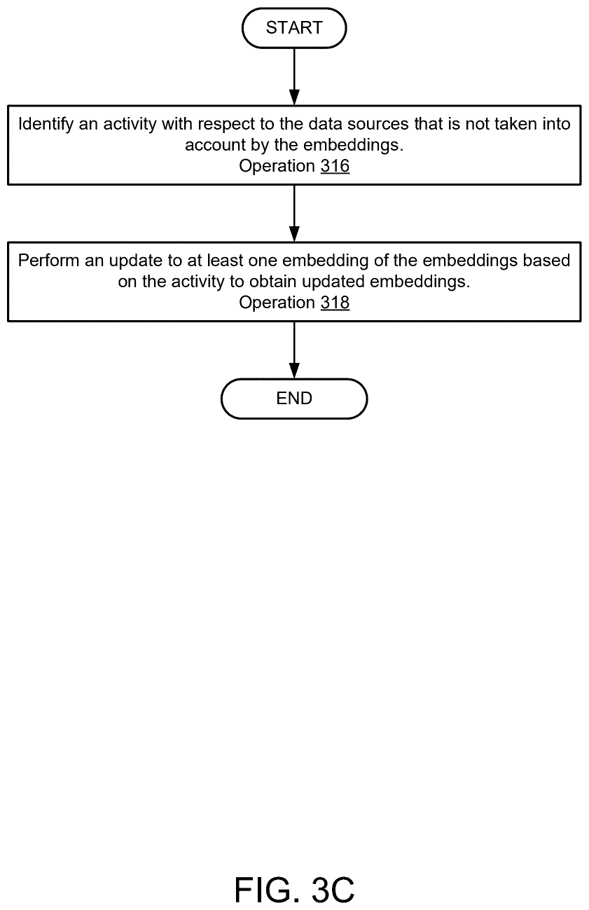

While providing their functionality, any of management system 100 and data processing systems 104 may perform all, or a portion, of the flows and methods shown in FIGS. 2A-3C.

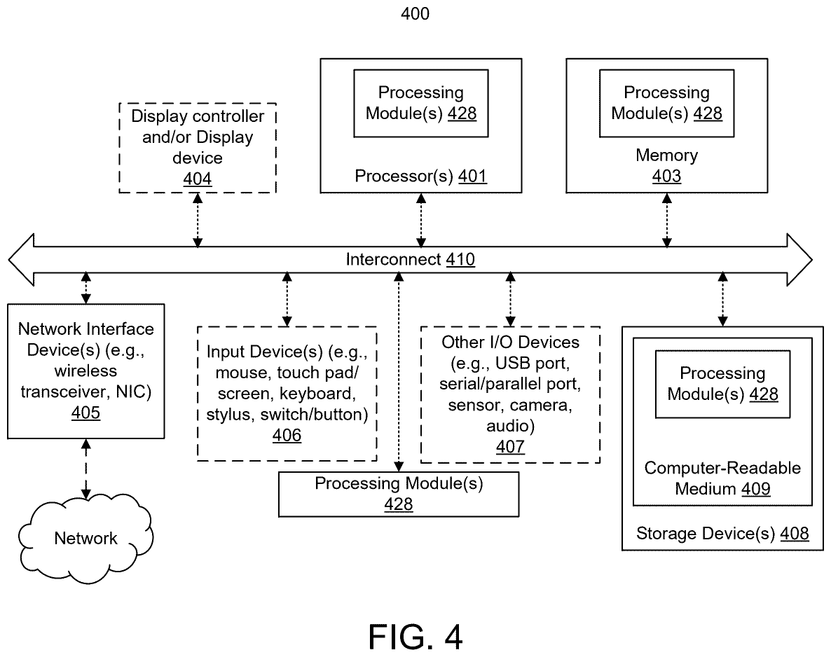

Any of (and/or components thereof) management system 100 and data processing systems 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 204, 208, etc.) is used to represent data structures, a second set of shapes (e.g., 202, 206, etc.) is used to represent processes performed using and/or that generate data, and a third set of shapes (e.g., 200, etc.) is used to represent large scale data structures such as databases.

Turning to FIG. 2A, a first data flow diagram in accordance with an embodiment is shown. The first data flow diagram may illustrate data used in and data processing performed in obtaining graph embeddings.

To obtain the graph embeddings (e.g., 208), a graph collection process (e.g., 202) may be performed. During the graph collection process (e.g., 202), a request (e.g., 238) may be received. The request (e.g., 238) may be received by the distributed system from an entity (e.g., (i) a user, (ii) an administrator, and/or (iii) any other stakeholder) of a distributed system. The request (e.g., 238) may be for a portion of data from the distributed system. The portion of the data may be used to facilitate desired computer implemented services by the distributed system. However, the request (e.g., 238) may be incompatible with information extraction frameworks for obtaining of the portion of the data. The request (e.g., 238) may be incompatible because the request (e.g., 238) may include a first format that includes (i) an unstructured format, (ii) an incompatible format, (iii) raw strings, and/or (iv) any other first format that cannot be ingested by the information extraction frameworks.

During the graph collection process (e.g., 202), the request (e.g., 238) may be used to perform a first search of a graph (e.g., 204) in a graph repository (e.g., 200). The first search may be performed by using a first portion (e.g., (i) a keyword, (ii) a statement or a clause, (iii) a identification of the entity who sent the request (e.g., 238), and/or (iv) any other first portion) of the request (e.g., 238) to identify the graph (e.g., 204) in the first search. The first search may include, using the first portion of the request (e.g., 238), (i) a keyword search, (ii) an identification search, (iii) a semantic search, etc. to obtain the graph (e.g., 204).

The graph (e.g., 204) may include a graph data structure. The graph data structure may include (i) nodes corresponding to data sources of the distributed system and/or (ii) edges between the nodes corresponding to relationships between the data sources. The data sources may include (i) data tables, (ii) data headers, (iii) data statistics, and/or (iv) any other sources of data that may be stored in (i) repositories, (ii) data lakes, (iii) data warehouses, (iv) application programming interfaces, and/or (v) any other component of the distributed system.

The graph repository (e.g., 200) may include a repository in which at least one graph data structure (e.g., 204, etc.) is stored in the distributed system. The at least one graph data structure may include at least one combination and/or at least one variation of the nodes and/or the edges. The first search may be performed using the graph repository (e.g., 200) and/or any portion of the request (e.g., 238) to obtain the graph (e.g., 204).

Using the request (e.g., 238) and/or the graph (e.g., 204), an embedding generation process (e.g., 206) may be performed. During the embedding generation process (e.g., 206), (i) the graph (e.g., 204) may be converted into the first portion of graph embeddings (e.g., 208), (ii) the request (e.g., 238) may be converted into a second portion of the request embeddings, and/or (iii) the first portion of graph embeddings (e.g., 208) and/or the second portion of request embeddings may be combined to generate the graph embeddings (e.g., 208).

The graph (e.g., 204) may be converted by using a graph embedding model. The graph embedding model may include (i) Node2Vec, (ii) graph attention networks, (iii) GraphSAGE (Graph Sample and Aggregation), etc. The request (e.g., 238) may be converted using a text embedding model. The text embedding model may include (i) Word2Vec, (ii) BERT (Bidirectional Encoder Representations from Transformations), (iii) FastText, etc. The first portion of graph embeddings (e.g., 208) and/or the second portion of request embeddings may be combined using (i) averaging, (ii) concatenation, (iii) generating a weighted sum, (iv) stacking into higher dimensions, and/or (v) any other combination method for embeddings.

The graph embeddings (e.g., 208) may include first numerical representations (e.g., first n-dimensional vectors and/or any other first numerical representations). The graph embeddings (e.g., 208) may further include first numerical representations corresponding to (i) the request (e.g., 238) and/or (ii) the graph (e.g., 204). The first portion of graph embeddings (e.g., 208) and/or the second portion of request embeddings may be related to each other based on at lease one data point (e.g., (i) a statistic, (ii) metadata, (iii) header, (iv) entity identification and/or (v) any other data point) included in at least one result of the first search of the graph collection process (e.g., 202).

Thus, via the first data flow illustrated in FIG. 2A, a system in accordance with an embodiment may obtain the graph embeddings (e.g., 208). Consequently, a distributed system may be more likely to be able to provide desired computer implemented services by obtaining embeddings corresponding to the graph (e.g., 204) and/or the request (e.g., 238).

Turning to FIG. 2B, a second data flow diagram in accordance with an embodiment is shown. The second data flow diagram may illustrate data used in and data processing performed in obtaining uncertainty scores and/or relevancy scores.

To obtain the uncertainty scores (e.g. 224) and/or relevancy scores (e.g., 232), an adaptive learning process (e.g., 214) may be performed. During the adaptive learning process (e.g., 214), graph embeddings (e.g., 208), user behaviors (e.g., 216) and/or new data source data (e.g., 218) may be ingested by the adaptive learning process (e.g., 214) to generate updated graph embeddings (e.g., 220).

The graph embeddings (e.g., 208) are described in the description of FIG. 2A. The user behaviors (e.g., 216) may include new actions performed by an entity (e.g., (i) a user, (ii) an administrator, and/or (iii) any other stakeholder) of the distributed system. The actions may include (i) retrieval, insertion, and/or updates of new types (e.g., (a) sales, (b) geodetic, (c) monitoring logs and/or (d) any other type data) that was not historically accessed and/or used by the entity, (ii) processing of new software that was not historically accessed and/or used by the entity, (iii) monitoring of at least one first event of the distributed system that was not historically monitored by the entity, etc. The new data source data (e.g., 218) may include (i) new data statistics, (ii) new data headers, (iii) new metadata, etc. of current data sources as well as new data sources.

During the adaptive learning process (e.g., 214), the user behaviors (e.g., 216) and/or new data source data (e.g., 218) may be converted to new embeddings. The new embeddings may be generated by ingesting, by an embedding generation model, the user behaviors (e.g., 216) and/or new data source data (e.g., 218). The embedding generation model may include (i) a word embedding model, (ii) an autoencoder, (iii) a neural network, etc.

Using the graph embeddings (e.g., 208), prior probabilistic embeddings may be generated. A prior probabilistic embedding of the prior probabilistic embeddings may be generated by computing a first mean embedding and/or a first covariance between at least two graph embeddings of the graph embeddings (e.g., 208). The prior probabilistic embeddings may include the first mean embedding and/or the first covariance between the at least two graph embeddings.

During the adaptive learning process (e.g., 214), at least one prior probabilistic embedding of the prior probabilistic embeddings may be combined with an at least one new embedding of the new embeddings. The at least one prior probabilistic embedding may be combined with the at least one new embedding using (i) averaging, (ii) concatenation, (iii) generating a weighted sum, (iv) stacking into higher dimensions, and/or (v) any other combination method for embeddings. Further, a first mean embedding and/or a first covariance may then be updated through a statistical estimation technique (e.g., (i) Bayesian updating, (ii) Kalman filtering, (iii) particle filtering, (iv) variational inference, and/or (v) any other updating process) to generate at least one posterior probabilistic embedding. Updated graph embeddings (e.g., 220) may include the at least one posterior probabilistic embedding.

The first mean embedding may include at least one first average of the at least one prior probabilistic embedding. The first covariance may include a first covariance matrix that includes first measures of first variations of the at least one prior probabilistic embedding.

As well, during the adaptive learning process (e.g., 214), the at least one new embedding may include a second mean and/or a second covariance. Thus, to combine the at least one prior probabilistic embedding and/or the at least one new embedding, a third mean embedding may be computed using the first mean embedding and/or the second mean embedding. Further, a third covariance may be computed using, for example, (i) a weighted sum, (ii) a pooled covariance, (iii) performing a recursive adjustment using the second covariance, (iv) performing the statistical estimation technique, and/or (v) any other combination method to generate the at least one posterior probabilistic embedding.

The second mean embedding may include at least one second average of the at least one new embedding. The second covariance may include a second covariance matrix that includes second measures of second variations of the at least one new embedding.

The updated graph embeddings (e.g., 220) may include second numerical representations (e.g., second n-dimensional vectors and/or any other second numerical representations). The graph embeddings (e.g., 208) may further include second numerical representations corresponding to combinations of the graph embeddings (e.g., 208) and/or the new embeddings of the user behaviors (e.g., 216) and/or the new data source data (e.g., 218). The updated graph embeddings (e.g., 220) may include the at least one posterior probabilistic embedding. The at least one posterior probabilistic embedding may include a third mean embedding and/or a third covariance. The third mean embedding may include at least one third average of the at least posterior probabilistic embedding. The third covariance may include a third covariance matrix that includes third measures of third variations of the at least one posterior probabilistic embedding.

Using the updated graph embeddings (e.g., 220), an uncertainty determination process (e.g., 222) may be performed. During the uncertainty determination process (e.g., 222), the updated graph embeddings (e.g., 220) may be used to generate the uncertainty scores (e.g., 224). The uncertainty scores (e.g., 224) may be generated by (i) generating at least one probabilistic vector using the updated graph embeddings (e.g., 220), (ii) computing at least one entropy based on the probabilistic vectors, and/or (iii) obtaining, from the at least one entropy, the uncertainty scores (e.g., 224).

The at least one probabilistic vector may be generated by (i) selecting at least one probability distribution that behaves similarly to at least one updated graph embedding of the updated graph embeddings (e.g., 220), and/or (ii) fitting parameters of the at least one probability distribution. The probability distribution, that is selected, may include (i) a normal distribution, (ii) a Poisson distribution, (iii) a binomial distribution, (iv) a uniform distribution, etc. The fitting parameters may include (i) a mean, (ii) a standard deviation, (iii) a variance, (iv) location parameters, (v) kurtosis, etc.

The at least entropy may be computed by computing the at least one entropy using the at least one probabilistic vector. The at least one entropy may be computed using a first mathematical expression (e.g., (i) Shannon's entropy, (ii) differential entropy for a Gaussian distribution, and/or (iii) any other first mathematical expression). The uncertainty scores (e.g., 224) may be obtained from the at least one entropy using a second mathematical expression in which a first value of the uncertainty scores (e.g., 224) is proportional to a second value of the at least one entropy.

Using the updated graph embeddings (e.g., 220), a graph updating process (e.g., 226) may be performed on the graph (e.g., 204). The graph (e.g., 204) is described in the description of FIG. 2A. During the graph updating process (e.g., 226), the graph (e.g., 204) may be updated to generate an updated graph (e.g., 228). The updated graph (e.g., 228) may be generated by passing values of updated graph embeddings (e.g., 220) between nodes of the graph (e.g., 204). Based on the passing of the values of the updated graph embeddings (e.g., 220), any component of a graph embedding of a node of the graph (e.g., 204) may be modified to generate updated nodes and/or updated edges. By generating the updated nodes and/or the updated edges, the updated graph (e.g., 228) may be generated.

The updated graph (e.g., 228) may include a graph data structure. The graph data structure may include (i) updated nodes corresponding to the data sources and/or (ii) updated edges between the updated nodes corresponding to relationships between the data sources. The updated nodes and/or updated edges may be based on at least first information of the user behaviors (e.g., 216) and/or at least second information of the new data source data (e.g., 218).

Using the updated graph (e.g., 228), a relevancy determination process (e.g., 230) may be performed to generate the relevancy scores (e.g., 224). During the relevancy determination process (e.g., 230), a trained graph neural network may be used to generate the relevancy scores (e.g., 224). The trained graph neural network may include (i) a trained graph convolution network, (ii) a trained graph attention network, (iii) a trained dynamic graph neural network, and/or (iv) any other trained graph neural network. The trained machine learning model may ingest (a) levels of importance (e.g., attention weights) between updated graph embeddings (e.g., 220) of the updated nodes, (b) a scalar matrix that has been generated by the trained machine learning model, etc. into an activation function to generate the relevancy scores (e.g., 232), etc.

The relevancy scores (e.g., 232) may include at least one level of relevancy between a first updated graph embedding and/or a second updated graph embedding of the update graph (e.g., 228). The at least one level of relevancy may correspond to (a) a number of neighboring updated nodes that are connected to an updated node by the updated edges, (b) lengths of the updated edges between the updated nodes, etc. A relevancy score of the first updated graph embedding of the relevancy scores (e.g., 232) may be large with (i) a proportionally large number of the neighboring updated nodes connected to a first updated node with updated first edges, (ii) at least one inversely short updated edge connected between the first node and/or a second node, and/or (iii) any other measure of relevancy between at least the first node and/or at least the second node.

Thus, via the second data flow illustrated in FIG. 2B, a system in accordance with an embodiment may obtain the uncertainty scores (e.g., 224) and/or the relevancy scores (e.g., 232). Consequently, a distributed system may be more likely to be able to provide desired computer implemented services by obtaining first levels of uncertainty and/or second levels of relevancy between the updated nodes and/or the updated neighboring nodes of the updated graph (e.g., 228).

Turning to FIG. 2C, a third data flow diagram in accordance with an embodiment is shown. The third data flow diagram may illustrate data used in and data processing performed in obtaining recommended data sources.

To obtain the recommended data sources (e.g., 236), a data source recommendation process (e.g., 234) may be performed. During the data source recommendation process (e.g., 234), an updated graph (e.g., 228), uncertainty scores (e.g., 224) and/or relevancy scores (e.g., 232) may be ingested by the data source recommendation process (e.g., 234) to generate the recommended data sources (e.g., 236).

The updated graph (e.g., 228), the uncertainty scores (e.g., 224) and the relevancy scores (e.g., 232) are described in the description of FIG. 2B.

During the data source recommendation process (e.g., 234), (i) discounted relevancy scores may be generated for data sources represented by the updated graph (e.g., 228) and/or (ii) the data sources may be rank-ordered based on the discounted relevancy scores to obtain the recommended data sources (e.g., 236).

The discounted relevancy scores may be generated by ingesting, by at least one mathematical expression, the uncertainty scores (e.g., 224) and/or the relevancy scores (e.g., 232), to generate the discounted relevancy scores. The at least one mathematical operation may include (i) at least one analytical expression, (ii) at least one numerically-determined expression, and/or (iii) any other type of mathematical operation.

The data sources may be rank-ordered by (i) performing a rank-ordering of the data sources based on discounted relevancy scores to obtain rank-ordered data sources and/or (ii) filtering the rank-ordered data sources based on (i) a threshold discounted level of the relevancy, (ii) a highest n number of data sources (e.g., in which n equals (a) three, (b) five, (c) ten, (d) twenty, and/or (e) any other predetermined number), and/or (iii) any other measure for filtering the rank-ordered data sources to obtain the recommended data sources (e.g., 236).

The recommended data sources (e.g., 236) may include at least one of the data sources. The recommended data sources (e.g., 236) may include the data sources that are not associated with low relevancy scores and/or high uncertainty scores. Thus, the recommended data sources (e.g., 236) may include the data sources that are likely relevant to new entity behaviors of user behaviors (e.g., 216) and/or new data source data (e.g., 218).

Thus, via the third data flow illustrated in FIG. 2C, a system in accordance with an embodiment may obtain the recommended data sources (e.g., 236). Consequently, a distributed system may be more likely to be able to provide desired computer implemented services by recommending relevant data sources for an entity (e.g., (i) a user, (ii) an administrator, and/or (iii) any other stakeholder of the distributed system) based on the user behaviors (e.g., 216) and/or the new data source data (e.g., 218).

Turning to FIG. 2D, a fourth data flow diagram in accordance with an embodiment is shown. The fourth data flow diagram may illustrate data used in and data processing performed in performing a system management process.

To perform the system management process (e.g., 246), an information request generation process (e.g., 242) may be performed. To perform the information request generation process (e.g., 242), a request template (e.g., 240) and/or recommended data sources (e.g., 236) may be used to generate an information request (e.g., 244).

The recommended data sources (e.g., 236) are described in the description of FIG. 2C. The request template (e.g., 240) may include a structured query template that is not processable by information extraction frameworks. The request template may not be processable because the request template includes placeholders, which can be replaced with data source identifiers. The data source identifiers may include (i) a column name, (ii) a field name, (iii) a data type, and/or (iv) any other data source identifier of the recommended data sources (e.g., 236). The information request (e.g., 244) may be generated by replacing the placeholders of the request template (e.g., 240) with the data source identifiers.

The information request (e.g., 244) may include the structured query template that is processable by the information extraction frameworks. The information request (e.g., 244) may be processable because the data source identifiers are included in the information request (e.g., 244). In processing of the information request (e.g., 244), the data source identifiers and/or any other statement of the information request (e.g., 244) may be used by the information extraction frameworks to identify and/or extract at least a portion of data from the data sources.

Thus, during the system management process (e.g., 246), the information request (e.g., 244) may be transmitted to and/or processed by the information extraction frameworks to (i) filter, (ii) prioritize, and/or (iii) retrieve the portion of the data. The portion of the data may include relevant data for use in the provisioning of the desired computer implemented services.

The portion of the data may be used to facilitate provisioning at least the portion of the desired computer implemented services by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

Thus, via the fourth data flow illustrated in FIG. 2D, a system in accordance with an embodiment may perform the system management process (e.g., 246). Consequently, a distributed system may be more likely to be able to provide desired computer implemented services by using the portion of the data obtained from processing of the information request (e.g., 244) to facilitate the provisioning of desired computer implemented services.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to provide desired computer implemented services using data stored in data sources of a distributed system. FIGS. 3A-3B illustrate a method that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of providing the desired computer implemented services using the data stored in the data sources of the distributed system in accordance with an embodiment is shown. The method may be performed, for example, by any of the components of the system of FIG. 1, and/or other components not shown therein.

At operation 300, a request may be obtained for data to be used to provide the desired computer implemented services. The request may be obtained by receiving the request from an entity of the distributed system. The entity may include (i) a user, (ii) an administrator, and/or (iii) any other stakeholder of the distributed system.

At operation 302, a level of uncertainty in relevancy of the data sources with respect to the data request may be computed for each of the data sources and based on the data request. The level of uncertainty may be computed by (i) generating, using a probability distribution and the updated embeddings, a probabilistic vector, the probability distribution including a type of variability expected of at least one embedding of the embeddings and the probabilistic vector including at least one fitted parameter of the probability distribution that is fitted to the at least one embedding, (ii) computing, using the probabilistic vector, an entropy of the probability distribution, and (iii) obtaining, using the entropy of the probability distribution, the level of the uncertainty of the relevancy of the one of the data sources.

The probabilistic vector may be generated by selecting a probability distribution that behaves similarly to at least one of the updated embeddings. The probability distribution may include (i) a normal distribution, (ii) a Poisson distribution, (iii) a binomial distribution, (iv) a uniform distribution, etc. The entropy may be computed by ingesting, by a first mathematical expression, at least the probability vector. The first mathematical expression may include (i) Shannon's entropy, (ii) differential entropy for a Gaussian distribution, and/or (iii) any other first mathematical expression. The level of the uncertainty may be obtained by ingesting, by a second mathematical expression, at least the entropy in which a first value of the level of the uncertainty is proportional to a second value of the at least the entropy.

At operation 304, an undiscounted level of the relevancy of the data sources with respect to the data request may be computed for each of the data sources. The undiscounted level of the relevancy may be computed by updating the embeddings associated with the nodes by propagating information between a first node of the nodes and a second node of the nodes based on an importance level between the first node and the second node. The embeddings may be updated by ingesting, by a trained graph neural network, the embeddings to propagate the information between the first node and the second node through a first edge.

At operation 306, a discounted level of the relevancy of the data sources with respect to the data request may be computed for each of the data sources using the undiscounted level and the level of uncertainty for each of the data sources. The discounted level of the relevancy may be computed by performing at least a mathematical operation using at least the undiscounted level of the relevancy and the level of the uncertainty of the relevancy to generate the discounted level of the relevancy, the mathematical operation at least in part discounting the undiscounted level of the relevancy based on the level of the uncertainty of the relevancy. The mathematical operation may be performed by ingesting, by a third mathematical expression, the undiscounted level of the relevancy and/or the level of the uncertainty of the relevancy to generate the discounted level of the relevancy.

Turning to FIG. 3B, at operation 308, recommended data sources to service the data request may be obtained using the discounted level of the relevancy for each of the data sources. The recommended data sources may be obtained by (i) rank-ordering the data sources based on discounted levels of the relevancy for each of the data sources and/or (ii) selecting a first portion of the data sources to obtain the recommended data sources, the first portion of the data sources ranking highest of the rank-ordering.

At operation 310, at least one information request may be obtained using the recommended data sources. The at least one information request may be obtained by (i) extracting data source identifiers from the recommended data sources and/or (ii) replacing placeholders of a request template with the data source identifiers to generate an information request. The request template may include the placeholders for the data source identifiers and/or at least one statement and/or at least one clause used to perform an information extraction by information extraction frameworks. The information extraction frameworks may include query execution engines compatible with the at least one information request.

At operation 312, the portion of the data may be obtained using the information request. The portion of the data may be obtained by processing, by the information extraction frameworks, the information request to extract the portion of the data from the data sources.

At operation 314, the portion of the data may be used to facilitate provisioning of at least the portion of the desired computer implemented services. The portion of the data may be used by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

The method may end following operation 314.

Thus, via the method shown in FIGS. 3A-3B, embodiments herein may likely improve a likelihood of providing the desired computer implemented services using the data stored in the data sources of the distributed system. By improving the likelihood of providing the desired computer implemented services using the data stored in the data sources of the distributed system, the distributed system may be more likely to provide desirable computer implemented services by, for example, identifying first levels of uncertainty and/or second levels of relevancy of the data sources, generating the recommended data sources based on the first levels and/or the second levels, etc.

As discussed above, the components of FIG. 1 may perform various methods to provide desired computer implemented services using data stored in data sources of a distributed system. FIG. 3C illustrates a method that may be performed by the components of the system of FIG. 1. In the diagram discussed below and shown in FIG. 3C, any of the operations may be repeated, performed in different orders, and/or performed in parallel with or in a partially overlapping in time manner with other operations.

Turning to FIG. 3C, a second flow diagram illustrating a method of providing the desired computer implemented services using the data stored in the data sources of the distributed system in accordance with an embodiment is shown. The method may be performed, for example, by any of the components of the system of FIG. 1, and/or other components not shown therein.

At operation 316, an activity with respect to the data sources may be identified that is not taken into account by the embeddings. The activity may be identified by receiving, from the distributed system, a notification that includes the activity. The activity may include (i) a new interaction of a user with respect to the data sources and/or (ii) a data change in characteristic of at least a portion of the data stored in the data sources.

At operation 318, an update to at least one embedding of the embeddings may be performed based on the activity to obtain updated embeddings. The update may be performed by ingesting, by an adaptive learning process, the at least one embedding and/or an activity embedding corresponding to the activity to obtain the updated embeddings.

The method may end following operation 318.

Thus, via the method shown in FIG. 3C, embodiments herein may likely improve a likelihood of providing the desired computer implemented services using the data stored in the data sources of the distributed system. By improving the likelihood of providing the desired computer implemented services using the data stored in the data sources of the distributed system, the distributed system may be more likely to provide desirable computer implemented services by, for example, receiving new activities of the entity of the distributed system, updating embeddings corresponding to data sources of the distributed system to include the new activities, etc.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for providing computer implemented services using data stored in data sources of a distributed system, the method performed by a data processing configured as a management system that manages the data sources of the distributed system and comprising:
obtaining a data request from a user for a first computer implemented services of the computer implemented services, the data request being serviceable using a portion of the data stored in data sources;
based on the data request, performing a real-time data source analysis process to obtain recommended data sources from which the portion of the data should be obtained by at least:
performing, by the management system, an adaptive learning process to detect in real time all new activities that have occurred within the distributed system since at least the obtaining of the data request, the new activities comprising at least a data change in characteristic of the data stored in the data sources;
based on the new activities detected in the real time:
computing, for each of the data sources, a level of uncertainty of relevancy of the data sources with respect to the data request;
computing, for each of the data sources, an undiscounted level of the relevancy of the data sources with respect to the data request;
computing, for each of the data sources, a discounted level of the relevancy of the data sources with respect to the data request using the undiscounted level and the level of uncertainty for each of the data sources;
obtaining, using the discounted level of the relevancy for each of the data sources, recommended data sources to service the data request;
generating, using the recommended data sources, at least one information request by replacing one or more placeholders in a request template with data source identifiers of the recommend data sources;
obtaining, using the at least one information request, the portion of the data; and
using the portion of the data to provide the first computer implemented services, wherein obtaining the portion of the data from the recommend data sources increases a likelihood of the first computer implemented services being provided to the user as compared to obtaining the portion of the data directly from the data sources without using the recommend data sources.

2. The method of claim 1, wherein obtaining the portion of the data comprises initiating servicing, by information extraction frameworks that manage access to the data stored in the data sources, the information request to obtain the portion of the data from the data sources.

3. The method of claim 2, wherein the data request is incompatible with the information extraction frameworks for obtaining of the portion of the data.

4. The method of claim 3, wherein the information request is a query usable to obtain the portion of the data, the information extraction frameworks comprising query execution engines compatible with the query.

5. The method of claim 1, wherein the level of uncertainty is computed using, at least in part, a graph data structure based on the data sources, the graph data structure comprising:
nodes corresponding to each of the data sources; and
edges between the nodes corresponding to relationships between the data sources.

6. The method of claim 5, wherein for one of the data sources, the level of uncertainty is based on embeddings for the one of the data sources.

7. The method of claim 6, wherein computing the undiscounted level of the relevancy of the data sources comprises updating the embeddings associated with the nodes by propagating information between a first node of the nodes and a second node of the nodes based on an importance level between the first node and the second node.

8. The method of claim 6, wherein the level of the uncertainty of the relevancy for the one of the data sources is based on historical changes to the embeddings associated with the new activities occurring within the distributed system, an embedding of the embeddings being based at least on a first activity among the new activities detected in the real time with respect to the one of the data sources, and the embedding being updated based on changes in the first activity.

9. The method of claim 8, further comprising:
before computing the level of the uncertainty of the relevancy:
identifying the first activity with respect to the data sources that is not taken into account by the embeddings; and
performing an update to at least one embedding of the embeddings based on the first activity to obtain updated embeddings.

10. The method of claim 9, wherein the first activity comprises at least one selected from a group consisting of:
a new interaction of the user with respect to the data sources; and
the data change in characteristic of at least the portion of the data stored in the data sources.

11. The method of claim 9, wherein for the one of the data sources, computing the level of the uncertainty of the relevancy of the data sources comprises:
generating, using a probability distribution and the updated embeddings, a probabilistic vector, the probability distribution comprising a type of variability expected of the at least one embedding of the embeddings and the probabilistic vector comprising at least one fitted parameter of the probability distribution that is fitted to the at least one embedding;
computing, using the probabilistic vector, an entropy of the probability distribution; and
obtaining, using the entropy of the probability distribution, the level of the uncertainty of the relevancy of the one of the data sources.

12. The method of claim 11, wherein computing the discounted level of the relevancy of the data sources comprises performing at least a mathematical operation using at least the undiscounted level of the relevancy and the level of the uncertainty of the relevancy to generate the discounted level of the relevancy, the mathematical operation at least in part discounting the undiscounted level of the relevancy based on the level of the uncertainty of the relevancy.

13. A non-transitory machine-readable medium having instructions stored therein, which when executed by a processor of a management system that manages data sources of a distributed system, cause the processor to perform operations for providing computer implemented services using data stored in the data sources, the operations comprising:
obtaining a data request from a user for a first computer implemented services of the computer implemented services, the data request being serviceable using a portion of the data stored in data sources;
based on the data request, performing a real-time data source analysis process to obtain recommended data sources from which the portion of the data should be obtained by at least:
performing, by the management system, an adaptive learning process to detect in real time all new activities that have occurred within the distributed system since at least the obtaining of the data request, the new activities comprising at least a data change in characteristic of the data stored in the data sources;
based on the new activities detected in the real time:
computing, for each of the data sources, a level of uncertainty of relevancy of the data sources with respect to the data request;
computing, for each of the data sources, an undiscounted level of the relevancy of the data sources with respect to the data request;
computing, for each of the data sources, a discounted level of the relevancy of the data sources with respect to the data request using the undiscounted level and the level of uncertainty for each of the data sources;
obtaining, using the discounted level of the relevancy for each of the data sources, recommended data sources to service the data request;
generating, using the recommended data sources, at least one information request by replacing one or more placeholders in a request template with data source identifiers of the recommend data sources;
obtaining, using the at least one information request, the portion of the data; and
using the portion of the data to provide the first computer implemented services, wherein obtaining the portion of the data from the recommend data sources increases a likelihood of the first computer implemented services being provided to the user as compared to obtaining the portion of the data directly from the data sources without using the recommend data sources.

14. The non-transitory machine-readable medium of claim 13, wherein obtaining the portion of the data comprises initiating servicing, by information extraction frameworks that manage access to the data stored in the data sources, the information request to obtain the portion of the data from the data sources.

15. The non-transitory machine-readable medium of claim 14, wherein the data request is incompatible with the information extraction frameworks for obtaining of the portion of the data.

16. The non-transitory machine-readable medium of claim 15, wherein the information request is a query usable to obtain the portion of the data, the information extraction frameworks comprising query execution engines compatible with the query.

17. A data processing system, comprising:
a processor; and
a memory coupled to the processor to store instructions, which when executed by the processor, cause the processor to perform operations for providing computer implemented services using data stored in data sources of a distributed system that includes the data processing system, the operations comprising:
obtaining a data request from a user for a first computer implemented services of the computer implemented services, the data request being serviceable using a portion of the data stored in data sources;
based on the data request, performing a real-time data source analysis process to obtain recommended data sources from which the portion of the data should be obtained by at least:
performing, by the data processing system, an adaptive learning process to detect in real time all new activities that have occurred within the distributed system since at least the obtaining of the data request, the new activities comprising at least a data change in characteristic of the data stored in the data sources;
based on the new activities detected in the real time:
computing, for each of the data sources, a level of uncertainty of relevancy of the data sources with respect to the data request;
computing, for each of the data sources, an undiscounted level of the relevancy of the data sources with respect to the data request;
computing, for each of the data sources, a discounted level of the relevancy of the data sources with respect to the data request using the undiscounted level and the level of uncertainty for each of the data sources;
obtaining, using the discounted level of the relevancy for each of the data sources, recommended data sources to service the data request;
generating, using the recommended data sources, at least one information request by replacing one or more placeholders in a request template with data source identifiers of the recommend data sources;
obtaining, using the at least one information request, the portion of the data; and
using the portion of the data to provide the first computer implemented services, wherein obtaining the portion of the data from the recommend data sources increases a likelihood of the first computer implemented services being provided to the user as compared to obtaining the portion of the data directly from the data sources without using the recommend data sources.

18. The data processing system of claim 17, wherein obtaining the portion of the data comprises initiating servicing, by information extraction frameworks that manage access to the data stored in the data sources, the information request to obtain the portion of the data from the data sources.

19. (canceled)

20. (canceled)

21. The method of claim 1, wherein obtaining the recommended data sources comprises:
performing a rank-ordering of the data sources based on the discounted levels of the relevancy of the data sources; and
filtering the rank-ordering of the data sources using a threshold discounted level of relevancy and a highest n number of the data sources to obtain the recommend data sources.

22. The method of claim 21, wherein the undiscounted level of the relevancy of the data sources is computed using at least a scalar matrix generated by a trained machine learning model, the scalar matrix being input by the trained machine learning model into an activation function to generate the undiscounted level of the relevancy of the data sources.
